(19) United States
(12) Patent Application Publication
(10) Pub. No.: US 2002/0169690 A1
(43) Pub. Date: Nov. 14, 2002

(54) Information rental system

(75) Inventor: Michiaki Yoshii, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/139,388

(22) Filed: May 7, 2002

(30) Foreign Application Priority Data
May 14, 2001 (JP) 2001-143028

(51) Int. Cl. G06F 17/60

(52) U.S. Cl. 705/26

(57) ABSTRACT

A data center side terminal system connected to a contents supply source side terminal through a dedicated line manages entertainment from the contents supply source side terminal as product data, a shop side terminal system provided at each shop manages the product data from the data center side terminal system, as well as writing the product data to a storage medium that is a high-speed and large-capacity disc with a read limiting mechanism in response to a request for rental, and a home side terminal system issues a reservation request for a product to be rented to the data center side terminal system.

### BACKGROUND OF THE INVENTION

1. Field of the Invention

The present invention relates to an information rental system for the rental of, for example, audio and video information.

2. Description of the Related Art

Audio and video information whose representatives are, for example, CD, videos and game programs, can be rented at rental shops.

The above-described rental shops involve a plurality of works such as lending work, returning work and product package arranging work to require numbers of clerks. Rental shops have another requirement that a wide variety of products should be prepared in order to meet customers' diversity of demands, which further requires a wide exhibition space.

In order to eliminate disadvantages such as the need of numbers of clerks and the need of a wide exhibition space, the use of such a digital information recording and reproducing device as proposed, for example, in Japanese Patent Laying-Open (Kokai) No. Heisei 06-349196 is intended to enable self-service information rental work, in which control information including a user number and a date of record is additionally recorded in a recording signal and based on the additional information, a party to sales and a term of rental are managed at the time of reproduction.

The use of the conventional digital information recording and reproduction device disclosed in the above-described literature has a problem that each customer is forced to rent or purchase a dedicated digital information recording and reproduction device.

Further problem is that at the writing of information to be rented on a medium at a rental shop by the above-described conventional digital information recording and reproduction device, its writing time is long. In a case, for example, where the medium is a DVD-RAM having a large storage capacity, writing is conducted at a speed of approximately twice a Max, so that writing a two-hour video requires at least an hour or so.

### SUMMARY OF THE INVENTION

Under these circumstances, an object of the present invention is to provide an information rental system enabling rental of audio and video information with ease and reliably.

According to one aspect of the invention, an information rental system comprises

a contents supply source terminal for supplying entertainment including created games, videos and music,

a data center side terminal system connected to said contents supply source terminal through a dedicated line for managing said entertainment from said contents supply source terminal as product data,

a shop side terminal system provided at each shop which is connected to said data center side terminal system through a large-capacity line for managing said product data from said data center side terminal system, as well as writing said product data to a high-speed and large-capacity disc with a read limiting mechanism in response to a request for rental, and

a home side terminal system connected to said data center side terminal system through a network for issuing a reservation request for the rental of a product to said data center side terminal system, as well as viewing and listening to or trying said product data from said high-speed and large-capacity disc with a read limiting mechanism written by said shop side terminal system.

In the preferred construction, said data center side terminal system includes

a product server for accumulating said entertainment as product data in a disc, as well as delivering the accumulated product data to said shop side terminal system provided at each shop,

a reservation server for giving an instruction to said product server to deliver product data to said shop side terminal system based on a reservation request from said home side terminal system, and

a settlement server for notifying a reservation number for settlement to a customer who wants a settlement of accounts together with telephone charges, as well as transmitting the reservation number for settlement and data of rental charges related to a telephone number of said communication terminal to a telephone company side terminal at the time of a settlement of accounts.

In another preferred construction, said product server analyzes use conditions of said product data at said shop side terminal system provided at each said shop to deliver product data whose frequency of use is high through said large-capacity line.

In another preferred construction, said shop side terminal system includes a product server for accumulating product data from said data center side terminal system in a disc, as well as transmitting product data meeting a request for viewing and listening or trial through a private line, and

a plurality of rental machines connected to said product server through said private line for writing product data meeting said request for viewing and listening or trial to said high-speed and large-capacity disc with a reading limiting mechanism.

In another preferred construction, said rental machine includes

a display unit for accepting search conditions of said product data and accessing said product server to display obtained information related to the product, as well as accepting input of a term or the frequency of viewing and listening or trial of said product data meeting said search conditions,

a writing device for writing said product data whose said accepted term or frequency is determined to said high-speed and large-capacity disc with a read limiting mechanism, and

a settlement mechanism for accepting payment of rental charges for said product data according to the prepaid system.

In another preferred construction, said home side terminal system includes

a communication terminal for notifying said reservation request for a product to be rented and that a settlement of accounts together with telephone charges is desired,

a game machine for viewing and listening to or trying said product data, and

a display device for displaying product data from said high-speed and large-capacity disc with a read limiting mechanism which is reproduced by said game machine.

According to another aspect of the invention, an information rental method comprises

a first step of supplying entertainment including created games, videos and music by a contents supply source side terminal,

a second step of managing said entertainment from said contents supply source side terminal as product data by a data center side terminal system connected to said contents supply source side terminal through a dedicated line,

a third step, by a shop side terminal system provided at each shop which is connected to said data center side terminal system through a large-capacity line, of managing said product data from said data center side terminal system, as well as writing said product data to a high-speed and large-capacity disc with a read limiting mechanism in response to a request for rental, and

a fourth step, by a home side terminal system connected to said data center side terminal system through a network, of issuing a reservation request for a product to be rented to said data center side terminal system, as well as viewing and listening to or trying said product data from said high-speed and large-capacity disc with a read limiting mechanism written by said shop side terminal system.

In the preferred construction, said second step includes

a fifth step, by a product server, of accumulating said entertainment as product data in a disc, as well as delivering the accumulated product data to said shop side terminal system provided at each shop,

a sixth step, by a reservation server, of giving an instruction to said product server to deliver product data to said shop side terminal system based on a reservation request from said home side terminal system, and

a seventh step, by a settlement server, of notifying a reservation number for settlement to a customer who wants a settlement of accounts together with telephone charges, as well as transmitting the reservation number for settlement and data of rental charges related to a telephone number of said communication terminal to a telephone company side terminal at the time of a settlement of accounts.

In another preferred construction, said fifth step includes a step of analyzing use conditions of said product data at said shop side terminal system provided at each said shop to deliver product data whose frequency of use is high through said large-capacity line.

In another preferred construction, said third step includes

a ninth step, by a product server, of accumulating product data from said data center side terminal system in a disc, as well as transmitting product data meeting a request for viewing and listening or trial through a private line, and

a tenth step, by a plurality of rental machines connected to said product server through said private line, of writing product data meeting said request for viewing and listening or trial to said high-speed and large-capacity disc with a reading limiting mechanism.

In another preferred construction, said tenth step includes

an eleventh step, by a display unit, of accepting search conditions of said product data and accessing said product server to display obtained information related to the product, as well as accepting input of a term or the frequency of viewing and listening or trial of said product data meeting said search conditions,

a twelfth step, by a writing device, of writing said product data whose said accepted term or frequency is determined to said high-speed and large-capacity disc with a read limiting mechanism, and

a thirteenth step, by a settlement mechanism, of accepting payment of rental charges for said product data according to the prepaid system.

In another preferred construction, said fourth step includes

a fourteenth step, by a communication terminal, of notifying said reservation request for a product to be rented and that a settlement of accounts together with telephone charges is desired,

a fifteenth step, by a game machine, of viewing and listening to or trying said product data, and

a sixteenth step, by a display device, of displaying product data from said high-speed and large-capacity disc with a read limiting mechanism which is reproduced by said game machine.

The information rental system according to the present invention is structured such that a contents supply source side terminal supplies entertainment including created games, videos and music, a data center side terminal system connected to the contents supply source side terminal through a dedicated line manages the entertainment from the contents supply source side terminal as product data, a shop side terminal system provided at each shop which is connected to the data center side terminal system through a large-capacity line manages the product data from the data center side terminal system, as well as writing the product data to a high-speed and large-capacity disc with a read limiting mechanism in response to a rental request, and a home side terminal system connected to the data center side terminal system through a network issues a reservation request for a product to be rented to the data center side terminal, as well as viewing and listening to or trying the product data from the high-speed and large-capacity disc with a read limiting mechanism whose write is conducted by the shop side terminal system. other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing one embodiment of an information rental system according to the present invention;

FIG. 2 is a diagram for use in explaining details of a rental machine shown in FIG. 1;

FIG. 3 is a diagram for use in explaining details of a home side terminal system shown in FIG. 1; and

FIG. 4 is a flow chart for use in explaining an information rental method in the information rental system of FIG. 1.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

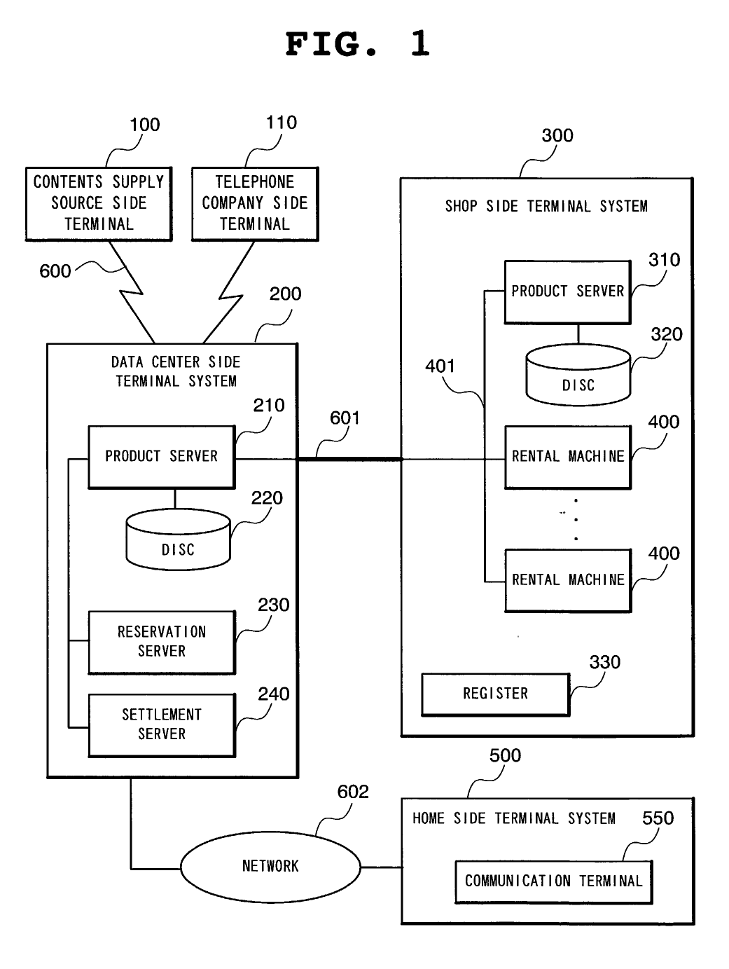

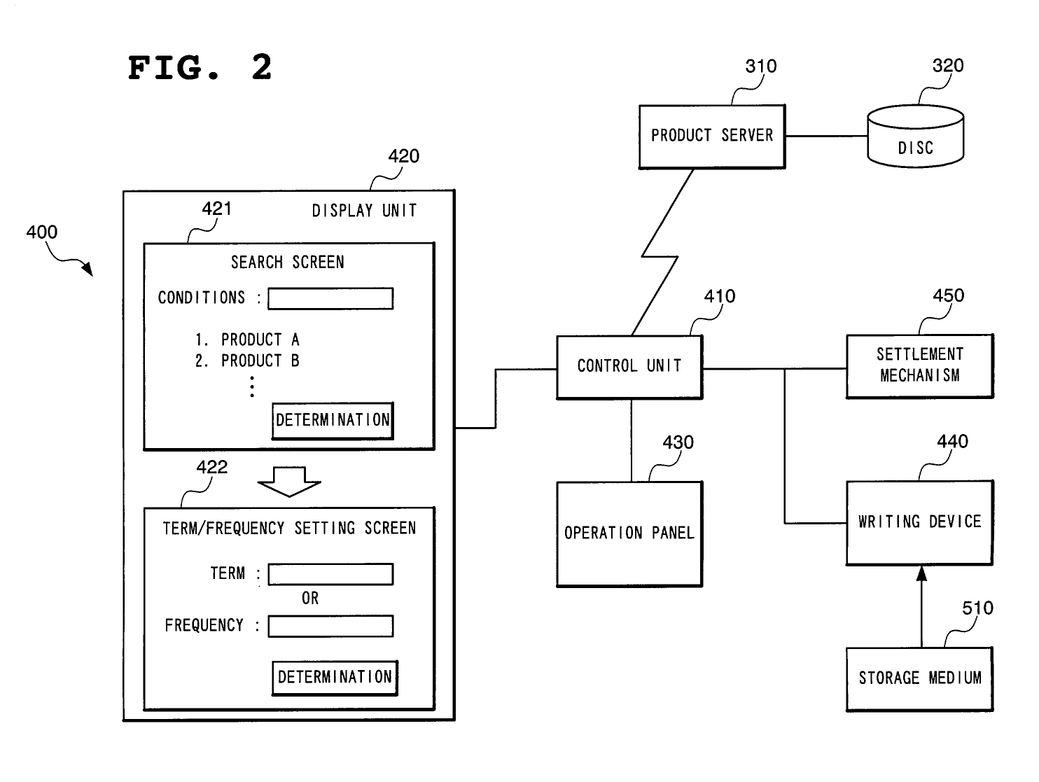

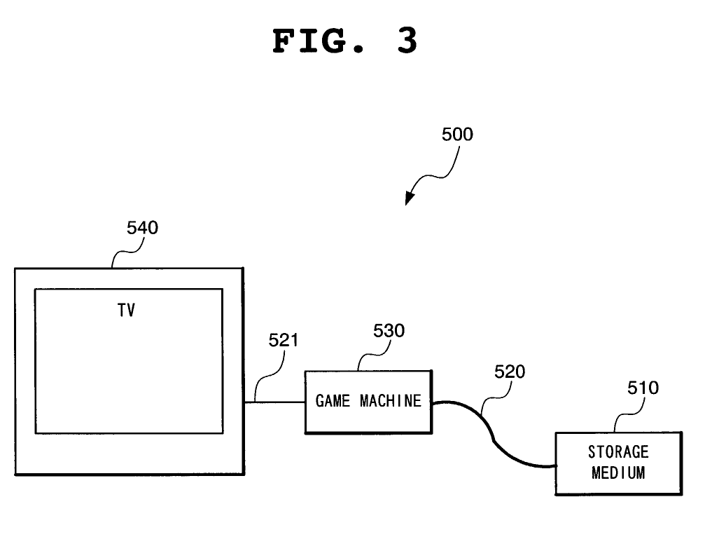

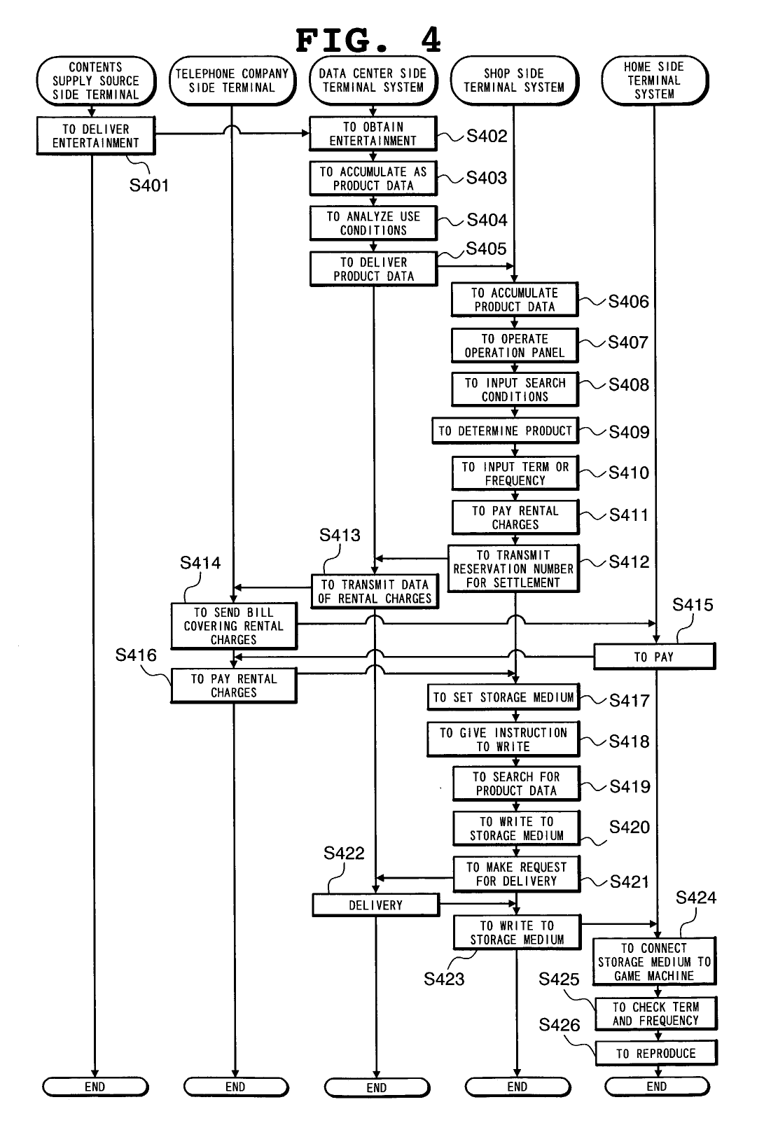

FIG. 1 is a diagram showing one embodiment of an information rental system according to the present invention, FIG. 2 is a diagram for use in explaining details of a rental machine shown in FIG. 1, FIG. 3 is a diagram for use in explaining details of a home side terminal system shown in FIG. 1, and FIG. 4 is a flow chart for use in explaining an information rental method in the information rental system of FIG. 1.

The information rental system shown in FIG. 1 includes a contents supply source side terminal 100, a telephone company side terminal 110, a data center side terminal system 200, a shop side terminal system 300 and a home side terminal system 500. The contents supply source side terminal 100 and the telephone company side terminal 110, and the data center side terminal system 200 are arranged to communicate with each other through a dedicated line 600, for example. The data center side terminal system 200 and the shop side terminal system 300 are arranged to communicate with each other through a large-capacity line 601. The data center side terminal system 200 and the home side terminal system 500 are arranged to communicate with each other through a network 602 composed of the Internet or telephone networks.

The contents supply source side terminal 100, which is—owned by a contents supply source side, supplies entertainment such as created games, videos and music to the data center side terminal system 200.

The telephone company side terminal 110, which is owned by a telephone company side, draws, for a customer who wants a settlement of accounts together with telephone charges, a bill including rental charges at the time of billing for telephone charges, as well as managing payment of rental charges to the data center side which are obtained by subtracting handling charges from collected telephone charges.

The data center side terminal system 200, which is owned by a data center side, manages the above-described entertainment supplied from the contents supply source side terminal 100 and includes a product server 210, a reservation server 230 and a settlement server 240.

The product server 210 accumulates the above-described entertainment from the contents supply source side terminal 100 as product data at a disc 220, as well as delivering the accumulated product data to the shop side terminal system 300. The product server 210 is also designed, for example, to analyze use conditions of product data of each shop side terminal system 300 to deliver product data whose frequency of use is high through the large-capacity line 601. Upon acceptance of a reservation from a customer by means of the reservation server 230, the product server 210 delivers product data corresponding to the reservation to the shop side terminal system 300.

The reservation server 230 has a reservation function of delivering product data to the shop side terminal system 300 according to a reservation request from a customer side.

The settlement server 240 notifies, to a customer who wants a settlement of accounts together with telephone charges, a reservation number for a settlement of accounts, as well as transmitting the reservation number for a settlement of accounts and data of rental charges related to a telephone number of a communication terminal 550 to the telephone company side terminal 110 at the time of settlement of accounts.

The shop side terminal system 300, which is owned by each shop, manages product data from the data center side terminal system 200 and includes a product server 310 and a rental machine 400.

The product server 310 accumulates product data from the data center side terminal system 200 in a disc 320, as well as transmitting the product data to a writing device 440 which will be described later through a private line 401 in response to a request for viewing and listing or trial.

The rental machine 400, which is provided in the plural, is connected to the product server 310 through -the—private line 401 and in charge of rental of product data and the like, whose details will be described later. The reference numeral 330 indicates a register for making a settlement of accounts involved in the rental of product data.

The home side terminal system 500 includes a communication terminal 550 such as a personal computer, a fixed telephone or a cellular telephone. The communication terminal 550 is designed to issue a reservation request for a product to be rented to the reservation server 230 of the data center side terminal system 200 through the network 602.

Next, the rental machine 400 will be detailed with reference to FIG. 2.

As shown in FIG. 2, the rental machine 400 includes a control unit 410, a display unit 420, an operation panel 430, the writing device 440 and a settlement mechanism 450.

The control unit 410 controls operation of each unit according to a predetermined control program. The display unit 420 displays information related to products which is obtained by accessing the product server 310 and has a search screen 421 and a term/frequency setting screen 422. The search screen 421 is a part to which search conditions are input and on which products A, B, etc. as product names meeting the conditions are displayed. The term/frequency setting screen 422 is-a screen which is displayed when the product A, B or the like is determined on the search screen 421 and which accepts input of a term or frequency of viewing and listening or trial of the determined product A, B or the like. The operation panel 430 is operated at the time of search and the like conducted on the display unit 420.

The writing device 440 is a unit for writing product data which is searched for on the search screen 421 and whose term/frequency is determined on the term/frequency setting screen 422 to a storage medium 510. The settlement mechanism 450 accepts payment of rental charges.

Next, the home side terminal system 500 will be detailed with reference to FIG. 3.

As shown in FIG. 3, the home side terminal system 500 includes, in addition to the above-described communication terminal 550, the storage medium 510, a game machine 530 and a TV 540. The storage medium 510 is connected to the game machine 530 through a connection cable 520. The game machine 530 is connected to the TV 540 through a connection cable 521.

The storage medium 510 is a part to which product data is written by the above-described writing device 440, which is a high-speed and large-capacity disc with read limiting mechanism proposed in Japanese Patent Application No. 2000-227691 and designed to be written with-product data within a-few minutes.

As the game machine 530, Play Station, Play Station 2, X-BOX, GAME-CUBE and the like being currently on the market can be used. The TV 540 is a part for displaying product data of the storage medium 510 reproduced by the game machine 530.

Next, description will be made of an information rental method in thus structured information rental system.

First, as shown in FIG. 4, a contract for the supply of product data is made between the contents supply source side terminal 100 and the data center side terminal system 200. After making the contract, entertainment such as a game, a video and music delivered by the contents supply source side terminal 100 is obtained by the data center side terminal system 200 through the dedicated line 600 (Steps 401 and 402). Entertainment including games, videos and music from the contents supply source side terminal 100 may be obtained not through the dedicated line 600 but by mailing of a medium and the like.

At the data center side terminal system 200, the obtained entertainment is accumulated as product data at the disc 220 by the product server 210 (Step 403). Upon completion of the accumulation of product data, the product server 210 analyzes use conditions of product data for each shop side terminal system 300 (Step 404) and delivers product data,-for example, whose frequency of use is high, to each shop side terminal system 300 through the large-capacity line 601 (Step 405). Such product data delivery may be conducted during slash hours at night etc. Then, the product data delivered to the shop side terminal system 300 is accumulated in the disc 320 by the product server 310 (Step 406).

When renting a product, a customer goes to a nearest shop. With a plurality of rental machines 400 disposed at the shop, upon operation of the operation panel 430 of one of the rental machines 400 (Step 407), the search screen 421 will be displayed on the display unit 420. Here, when search conditions are entered (Step 408), the products A, B, etc. meeting the search conditions are displayed on the search screen 421. Here, when there is a product that the customer wants to view and listen or try among the products A, B, etc., the customer enters the number corresponding to the product A, B or the like through the operation panel 430 and when selecting the determination on the search screen 421 (Step 409), the term/frequency setting screen 422 will be displayed on the display unit 420.

In a case where the customer has already made a reservation at the reservation server 230 of the data center side terminal system 200 as will be described later, just entering a reservation number leads to display of a product the customer wants to view and listen or try.

Since the term/frequency setting screen 422 urges the customer to input a term or the frequency of viewing and listening or trial of the determined product A, B or the like, he/she inputs the term or the frequency of viewing and listening or trial through the operation panel 430 to select the determination (Step 410). When he/she wants to know the contents of the determined product A, B or the like, it is possible to call up detailed data, sample videos, etc. and have them displayed on the display unit 420.

After the product is determined which the customer wants to view and listen or try, the customer pays rental charges at the settlement mechanism 450 or the register 330 in the shop (Step S411). In this case, rental charges may be paid according to the predetermined number of times when write is allowed as in the prepaid system. The number of times when write is allowed which is accumulated by the prepaid system may be recorded in the storage medium 510 to decrement the number of times when write is allowed every time writing is conducted. The number of times when write is allowed can be incremented again by the prepaid system.

On the other hand, when a customer wants a settlement of accounts together with telephone charges, transmission of a reservation number for settlement notified to the customer by the settlement server 240 of the data center side-terminal-system 200 from the communication terminal 550 to the settlement sever 240 (Step 412) enables a settlement of accounts together with telephone charges as well.

In this case, while the telephone number of the communication terminal 550 having arrived and the reservation number for settlement which is transmitted after the connection is established are stored by the settlement server 240, the telephone number and data of the rental charges related to the reservation number for a settlement of accounts are transmitted to the telephone company side terminal 110 (Step 413). Then, at the telephone company side terminal 110, a bill including rental charges is drawn at the time of billing for telephone charges and sent to the customer (Step 414). In addition, upon payment by the customer (Step 415), the telephone company side terminal 110 makes a payment to the data center side for rental charges obtained by subtracting handling charges from the collected telephone charges (Step 416).

On the other hand, after the determination of the product the customer wants to view and listen or try is completed to set the storage medium 510 at the writing device 440, when a writing instruction is given from the operation panel 430, the product data of the determined product is searched for in the disc 320 by the product server 310 and the product data and the term information and/or frequency information are written to the storage medium 510 (Steps 417 to 420). At this time, the product data searched for in the disc 320 is applied to the writing device 440 through the private line 401, so that the writing device 440 writes the data on the storage medium 510.

By contraries, when there is no product data to be searched for in the disc 320, a delivery request is issued from the product server 310 to the product server 210 (Step 421). At this time, when the product server 210 searches the disc 220 for product data whose delivery is requested and delivers the data to the product server 310 (Step 422), the product data is applied to the writing device 440 through the private line 401, so that the writing device 440 writes the data on the storage medium 510 (Step 423).

In a case where the customer makes a reservation in advance for a product he/she wants to view and listen or try at the reservation server 230 of the data center side terminal system 200 by means of the communication terminal 550, no search for the disc 320 is conducted by the product server 310 and the product data delivered from the product server 210 to the product server 310 is applied to the writing device 440, whereby the data is written on the storage medium 510 by the writing device 440. By thus making a reservation for a product the customer wants to view and listen or try at the reservation server 230 of the data center side-terminal system 200 by means of the communication terminal 550 in advance, a waiting time can be saved related to the search of the disc 320 by the product server 310, to a delivery request from the product server 310 to the product server 210 and also to delivery from the product server 210 to the product server 310 to further reduce a time required for writing to the storage medium 510 by the writing device 440.

After writing to the storage medium 510 by the writing device 440 is completed, the customer returns home and connects the storage medium 510 to the game machine 530 as the communication terminal 550 of the home side terminal system 500 through the connection table 520 (Step 424).

At this time, the read limiting mechanism of the storage medium 510 checks a term or the frequency when viewing and listening or trial is possible (Step 425) and when within the term or the frequency, viewing and listening or trial is allowed. As a result, the product data written on the storage medium 510 is reproduced by the game machine 530 (Step 426) and viewed and listened or tried by means of the TV 540.

As described in the foregoing, the present embodiment is structured such that the contents supply source side terminal 100 supplies entertainment including created games, videos and music, the data—-center side—terminal-system 200 connected to the contents supply source side terminal 100 through the dedicated line 600 manages the entertainment from the contents supply source side terminal 100 as product data, the shop side terminal system 300 provided at each shop which is connected to the data center side terminal system 200 through the large-capacity line 601 manages the product data from the data center side terminal system 200, as well as writing product data to the storage medium 510 which is a high-speed and large-capacity disc with a read limiting mechanism in response to a request for rental, and the home side terminal system 500 connected to the data center side terminal system 200 through the network 602 issues a reservation request for a product a customer wants to rent to the data center side terminal system 200, as well as viewing and listening to or trying the product data from the storage medium 510 to which write is made by the shop side terminal system 300.

Because product data according to a rental request is thus written to the storage medium 510 which is a high-speed and large-capacity disc with a read limiting mechanism and viewing and listening or trial of the product data of the storage medium 510 is conducted by means of the game machine 530 widely used, the need of a dedicated reproduction device is eliminated.

In addition, since the storage medium 510 is a high-speed and large-capacity disc with a read limiting mechanism as described above, a writing time by the writing device 440 of the shop side terminal system 300 can be drastically reduced to enable a customer to write by himself/herself.

Moreover, since rental of information is conducted by a customer through his/her own operation according to the display contents of the display unit 420 of the rental machine 400 in the shop side terminal system 300, the need of a plurality of works including lending work, returning work and product package arranging work which are conventionally conducted by clerks is eliminated.

At the shop side terminal system 300, because while product data is accumulated at the disc 320 by the product server 310, it is transmitted from the product server 310 to the rental machine 400 upon a rental request, no opportunity for rental will be missed due to out of stock.

With a rental request for product data which is not accumulated in the disc 320, the product data will be delivered from the data center side terminal system 200, whereby no opportunity for rental will be missed due to out of stock.

Furthermore, since product data is accumulated in the disc 320 by the product server 310 at the shop side terminal system 300, it is not necessary to prepare a wide variety of products for meeting-customers' diversity of demands and is therefore necessary to have only a small exhibition space.

Moreover, since the storage medium 510 is a high-speed and large-capacity disc with a read limiting mechanism as described above to limit a term of use or the frequency of use, it will be unnecessary to go to a rental shop for returning, which promotes customers' convenience.

Since customers are allowed to search for a desired product by means of the rental machine 400 of the shop side terminal system 300, they are no longer required to look around a rental shop for products.

In addition, since information rental can be conducted by a customer on his/her own using the rental machine 400 of the shop side terminal system 300, he/she needs not to be attended by a clerk, which gives him/her an opportunity to rent a product for adults only without hesitation.

As to a settlement of accounts for rental charges for the rental of information, various means can be used such as the settlement mechanism 450 of the rental machine 400, the register 330, addition to telephone charges and the prepaid system to improve convenience in the settlement of accounts.

As described in the foregoing, the information rental system according to the present embodiment enables-rental of audio-and video information with ease and with reliability because it is structured such that the contents supply source side terminal supplies entertainment including created games, videos and music, the data center side terminal system connected to the contents supply source side terminal through the dedicated line manages the entertainment from the contents supply source side terminal as product data, the shop side terminal system provided at each shop which is connected to the data center side terminal system through the large-capacity line manages the product data from the data center side terminal system, as well as writing product data to a high-speed and large-capacity disc with a read limiting mechanism in response to a request for rental, and the home side terminal system connected to the data center side terminal system through the network issues a reservation request for a product that a customer wants to rent to the data center side terminal system, as well as viewing and listening to or trying the product data from the high-speed and large-capacity disc with a read limiting mechanism to which write is made by the shop side terminal system.

Although the invention has been illustrated and described with respect to exemplary embodiment thereof, it should be understood by those skilled in the art that the foregoing and various other changes, omissions and additions may-be made-therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. An information rental system comprising:
a contents supply source terminal for supplying entertainment including created games, videos and music, a data center side terminal system connected to said contents supply source terminal through a dedicated line for managing said entertainment from said contents supply source terminal as product data,
a-shop side-terminal system provided at each shop which is connected to said data center side terminal system through a large-capacity line for managing said product data from said data center side terminal system, as well as writing said product data to a high-speed and large-capacity disc with a read limiting mechanism in response to a request for rental, and
a home side terminal system connected to said data center side terminal system through a network for issuing a reservation request for the rental of a product to said data center side terminal system, as well as viewing and listening to or trying said product data from said high-speed and large-capacity disc with a read limiting mechanism written by said shop side terminal system.

2. The information rental system as set forth in claim 1, wherein
said data center side terminal system includes:
a product server for accumulating said entertainment as product data in a disc, as well as delivering the accumulated product data to said shop side terminal system provided at each shop,
a reservation server for giving an instruction to said product server to deliver product data to said shop side terminal system based on a reservation request from said home side terminal system, and
a settlement server for notifying a reservation number for settlement to a customer who wants a settlement of accounts together with telephone charges, as well as transmitting the reservation number for settlement and data of rental charges related to a telephone number of said communication terminal to a telephone company side terminal at the time of a settlement of accounts.

3. The information rental system as set forth in claim 2, wherein
said product server analyzes use conditions of said product data at said shop side terminal system provided at each said shop to deliver product data whose frequency of use is high through said large-capacity line.

4. The information rental system as set forth in claim 1, wherein
said shop side terminal system includes:
a product server for accumulating product data from said data center side terminal system in a disc, as well as transmitting product data meeting a request for viewing and listening or trial through a private line, and
a plurality of rental machines connected to said product server through said private line for writing product-data meeting said request-for viewing and listening or trial to said high-speed and large-capacity disc with a reading limiting mechanism.

5. The information rental system as set forth in claim 4, wherein
said rental machine includes:
a display unit for accepting search conditions of said product data and accessing said product server to display obtained information related to the product, as well as accepting input of a term or the frequency of viewing and listening or trial of said product data meeting said search conditions,
a writing device for writing said product data whose said accepted term or frequency is determined to said high-speed and large-capacity disc with a read limiting mechanism, and
a settlement mechanism for accepting payment of rental charges for said product data according to the prepaid system.

6. The rental information system as set forth in claim 1, wherein
said home side terminal system includes:
a communication terminal for notifying said reservation request for a product to be rented and that a settlement of accounts together with telephone charges is desired,
a game machine for viewing and listening to or trying said product data, and
a display device for displaying product data from said high-speed and large-capacity disc with a read limiting mechanism which is reproduced by said game machine.

7. An information rental method comprising:
a first step of supplying entertainment including created games, videos and music by a contents supply source side terminal,
a second step of managing said entertainment from said contents supply source side terminal as product data by a data center side terminal system connected to said contents supply source side terminal through a dedicated line,
a third step, by a shop side terminal system provided at each shop which is connected to said data center side terminal system through a large-capacity line, of managing said product data from said data center side terminal system, as well as writing said product data to a high-speed and large-capacity disc with a read limiting mechanism in response to a request for rental, and
a fourth step, by a home side terminal system connected to said data center side terminal system through-a network, of issuing a reservation request for a product to be rented to said data center side terminal system, as well as viewing and listening to or trying said product data from said high-speed and large-capacity disc with a read limiting mechanism written by said shop side terminal system.

8. The information rental method as set forth in claim 7, wherein
said second step includes:
a fifth step, by a product server, of accumulating said entertainment as product data in a disc, as well as delivering the accumulated product data to said shop side terminal system provided at each shop,
a sixth step, by a reservation server, of giving an instruction to said product server to deliver product data to said shop side terminal system based on a reservation request from said home side terminal system, and
a seventh step, by a settlement server, of notifying a reservation number for settlement to a customer who wants a settlement of accounts together with telephone charges, as well as transmitting the reservation number for settlement and data of rental charges related to a telephone number of said communication terminal to a telephone company side terminal at the time of a settlement of accounts.

9. The information rental method as set forth in claim 8, wherein
said fifth step includes a step of analyzing use conditions of said product data at said shop side terminal system provided at each said shop to deliver product data whose frequency of use is high through said large-capacity line.

10. The information rental method as set forth in claim 7, wherein
said third step includes:
a ninth step, by a product server, of accumulating product data from said data center side terminal system in a disc, as well as transmitting product data meeting a request for viewing and listening or trial through a private line, and
a tenth step, by a plurality of rental machines connected to said product server through said private line, of writing product data meeting said request for viewing and listening or trial to said high-speed and large-capacity disc with a reading limiting mechanism.

11. The information rental method as set forth in claim 10, wherein
said tenth step includes:
an eleventh step, by a display unit, of accepting search-conditions-of said product data and accessing said product server to display obtained information related to the product, as well as accepting input of a term or the frequency of viewing and listening or trial of said product data meeting said search conditions,
a twelfth step, by a writing device, of writing said product data whose said accepted term or frequency is determined to said high-speed and large-capacity disc with a read limiting mechanism, and
a thirteenth step, by a settlement mechanism, of accepting payment of rental charges for said product data according to the prepaid system.

12. The rental information method as set forth in claim 7, wherein
said fourth step includes:
a fourteenth step, by a communication terminal, of notifying said reservation request for a product to be rented and that a settlement of accounts together with telephone charges is desired,
a fifteenth step, by a game machine, of viewing and listening to or trying said product data, and
a sixteenth step, by a display device, of displaying product data from said high-speed and large-capacity disc with a read limiting mechanism which is reproduced by said game machine.
